(19) United States
(12) Patent Application Publication
(10) Pub. No.: US 2002/0149147 A1
(43) Pub. Date: Oct. 17, 2002

(54) Toggle clamp construction

(75) Inventor: Peter Schauss, Florsheim (DE)

Correspondence Address: Russell D. Orkin, Esq., 700 Koppers Building, 436 Seventh Avenue, Pittsburgh, PA, 15219-1818, US

(73) Assignee: DE-STA-CO Metallerzeugnisse GmbH

(21) Appl. No.: 09/833,725

(22) Filed: Apr. 12, 2001

(51) Int. Cl. B25B 1/14

(52) U.S. Cl. 269/228

(57) ABSTRACT

The invention is concerned with a toggle clamp construction comprising an actuator cylinder including a linearly guided piston rod. The piston rod engages a header of the construction arranged on one end or the actuator cylinder where it is connected, via an adjusting mechanism, to a clamp arm pivotally located on the header. The header is provided with at least one engaging hole; an extension is disposed an the piston rod. For selectively fixing the opening angle which is to be taken by the clamp arm after opening the clamp mechanism, a support element for a stop is detachably inserted in the engaging hole. The said stop protrudes into the path or adjustment of the extension of the piston rod, thereby determining the opening angle.

### BACKGROUND OF THE INVENTION

1. Field of the Invention

The present invention is concerned with toggle clamp constructions for clamping work pieces; in particular, its relates to such toggle clamps that are furnished with elements for confining the opening angle of the clamp arms of such mechanisms.

2. Description of the Prior Art

Clamp mechanism of the afore-described type have been disclosed, for example, by German Patent No. 136 16 441 C1 showing a so-called closed clamp head including an inquiry cassette adapted to be inserted in an engaging hole.

To confine the opening angle of the clamp arm of clamping mechanism of the afore-described type that can also consist of a clamp head opening in a fork-type way, German Patent Application No. 22 22 686 teaches to provide, within the end of the actuator cylinder facing away from the clamp head, a stop in the form of a pin serving as a path limiter for the piston moving during opening of the clamp mechanism toward the cylinder bottom, thereby defining the opening angle. The said pin can be axially adjusted by means of a bolt. Apart from the fact that such an adjustability by means of a bolt requires special sealing measures, the arrangement or assembly of such a stop means requires a special design at least of the bottom closure of the actuator cylinder, i.e. mass-produced or commercially available actuator cylinders cannot (readily) be used.

It is desirable that the clamp arm-opening angle of clap constructions of the afore-described type be adjustable because the opening angle of the clamp mechanism, for timing reasons, can be adjusted as large as necessary but as small as possible because in respect of timed finishing lines, for example, for the manufacture of car bodies or parts thereof, which is the principal field of application of clamping mechanisms of this type, the time required for opening and closing such a clamp mechanism is of decisive importance for the respective tied sequence.

### OBJECTS AND SUMMARY OF THE INVENTION

It is, therefore, a primary object of the invention to so improve clamp mechanisms of the afore-described type that the adjustability of the limitation of the opening angle be insured independently of the actuator cylinder, and effected by means of a stop easily provided on the clamp head of the clamp construction in connection with the piston rod of the actuator cylinder.

A second object is to provide a new and improved clamp mechanism wherein the stop of the opening angle is to be adjustably arranged on the clamp head of the mechanism.

A third object of the invention is to provide a new and improved clamp construction wherein the opening position as reached is to be electrically displayed.

A further object of the invention is to provide a new and improved clamp mechanism wherein the gap or slot inherently provided on clamping mechanisms of this type be used on the clamp head to enable the stop to be accommodated therein.

The afore-going and other objects are attained with one aspect of the invention through a clamping mechanism comprising an actuator cylinder having a linearly guided piston rod in engagement with a header arranged on one end of the actuator cylinder, where it is connected, via an adjusting mechanism, to a clamp arm pivotally located on the header. In the area between the clamp arm and the actuator cylinder, the header includes an engaging hole, with an extension being provided on the piston rod of the actuator cylinder. In the practice of the invention, an element is detachably mounted in the engaging hole, which in cooperation with the extension of the piston rod forms a stop for limiting the opening angle of the clamp arm.

In the practice of the invention, the engaging hole anyway available in clamp assemblies of the afore-described type for the so-called end position inquiry cassette otherwise to be inserted therein, is used to insert therein and fix thereto, in lieu thereof, an element which together with the extension arranged on the piston rod of a correspondingly stable configuration, forms a stop for limiting the opening angle. Depending on the opening angle to be adjusted for the clamp arm, a correspondingly designed element is inserted into the engaging hole which defines the maximum path of displacement of the piston rod toward the pressure cylinder. A stock of elements designed in accordance with the path of displacement to be adjusted can be stored at the place of use of the clamp mechanism, to select therefrom the desired element in case of a switch-over of the clamp mechanism. However, by way of alternative it is preferred to provide an adjustable stop yet to be explained hereinafter.

### BRIEF DESCRIPTION OF THE DRAWINGS

Various objects, features and attendant advantages of the present invention will be sore fully appreciated as the same becomes better understood from the following detailed description thereof, when considered in connection with the accompanying drawings, wherein

FIG. 1 shows schematically a side view of the clamping mechanism of the invention of the closed-housing type;

FIG. 2 shows schematically a rear view of the clamping mechanism comprising a fork-type header;

FIG. 3 is a perspective view of an alternative form of embodiment of the element to be inserted into the engaging hole;

FIG. 4 is a side view of an alternative form of embodiment of the element of FIG. 3;

FIG. 5 is a sectional side view of the clamping mechanism having a closed header, and of a preferred form of embodiment of the element comprising inquiry means;

FIG. 6 is a front view of the element according to FIG. 5;

FIG. 7 is a sectional side view of the element of FIG. 5;

FIG. 8 is a rear view of the element according to FIG. 5; and

FIG. 9 is a sectional view of the element of FIG. 5 taken along the line A-A in FIG. 7.

### DETAILED DESCRIPTION OF THE PREFERRED EMBODIMENTS

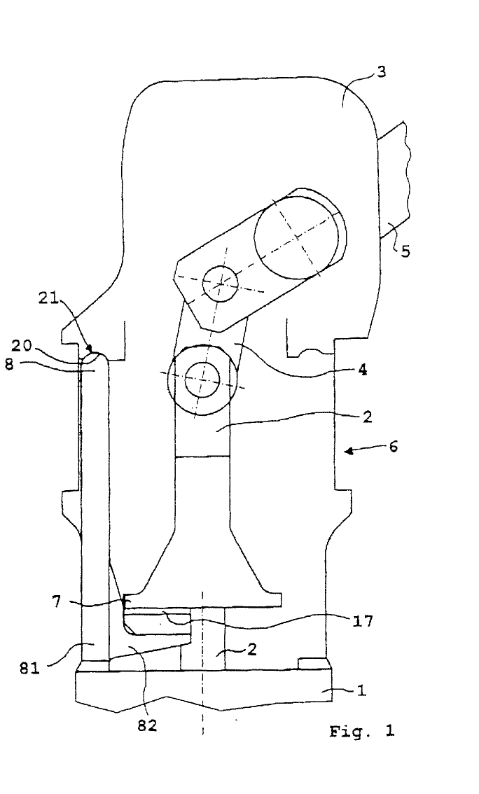

Referring to FIG. 1, the toggle clamp includes an actuator cylinder 1 comprising a linearly guided piston rod 2 in engagement with a header 3 of the construction, arranged on one end of the actuator cylinder 1, where it is connected, via a link element 4, to a clams arm 5 pivotally disposed on the header 3, The said header 3, in the area between the clamp arm 5 and the actuator cylinder 1, is provided with an engaging hole 6. Arranged on the piston rod 2 is an extension 7. Detachably mounted in the said engaging hole 6 of the header 3 is a support element 8 extending in parallel to the piston rod 2. Arranged on the support element 8, in the bottom end area thereof, is a stop 82 which, for limiting the opening angle of the clamp arm 5, protrudes into the path of adjustment of the extension 7 arranged on the piston rod 2.

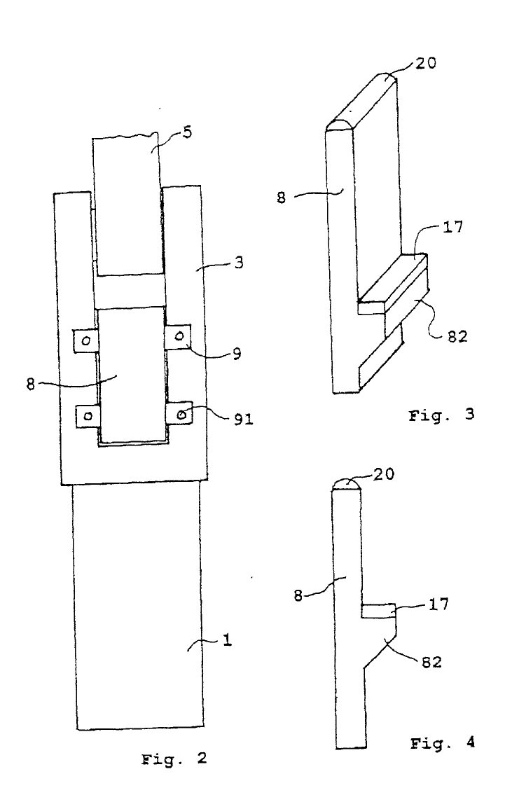

If the stop 82 forms an integral unit with the support element 8 as shown, for example, in FIGS. 3, 4, one or the other of said support elements 8 is respectively inserted into the header 3, depending on the desired opening angle, with the support element 8 with stop 82 thereof leading to a larger opening angle of the clamp arm 5 than the support element shown in FIG. 4.

However, an embodiment wherein the stop 82 can he fixed to the support element 8 in varying positions of vertical height is to be preferred, which will he explained hereinafter in greater detail.

In order to enable the support element to be easily inserted into header 3, support element 8 on one end thereof is provided with an arcuate radius 20 (see FIG. 1) inserted into a conforming negative arcuate radius 21 on the header 3, while the other end 81 is detachably fixed to the header, with the said fixation being effected, for example, by a bolt not shown in any detail.

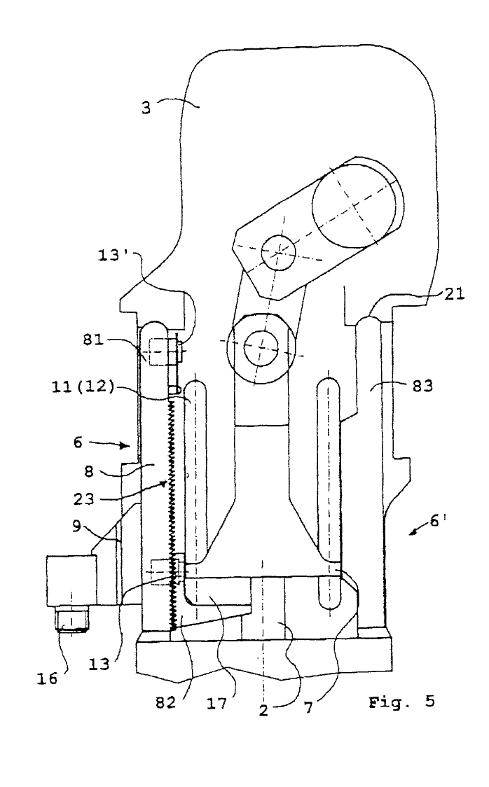

To exclude, as mentioned before, the need for a plurality of support elements 8 with differently associated stops 82, the form of embodiment as shown in FIG. 5 is the preferred one, wherein the support element 8, on the side facing the piston rod, is provided with a toothing 23 engaged by stop 82 provided with a conforming toothing.

To enable an attenuated mounting of the extension 7 on the stop, preferably a pad 17 s arranged on the stop for attenuating purposes. Conversely, a pad 171 can be arranged underneath extension 7, attaining the same effect (see FIG. 1).

To enable the two end positions of the clamp arm 5 to be electrically inquired, a sensor 13′ sensing the clamping position and a sensor 13 sensing the opening position, are arranged on the support element 8 in a space-adjustable way.

With such sensor means being disposed on the mechanism, the sensor 13 sensing the opening position, preferably, is arranged adjustably on the stop 82 provided on the support element. Hence, when adjusting the stop 82 the sensor 13 sensing the opening position automatically is also adjusted.

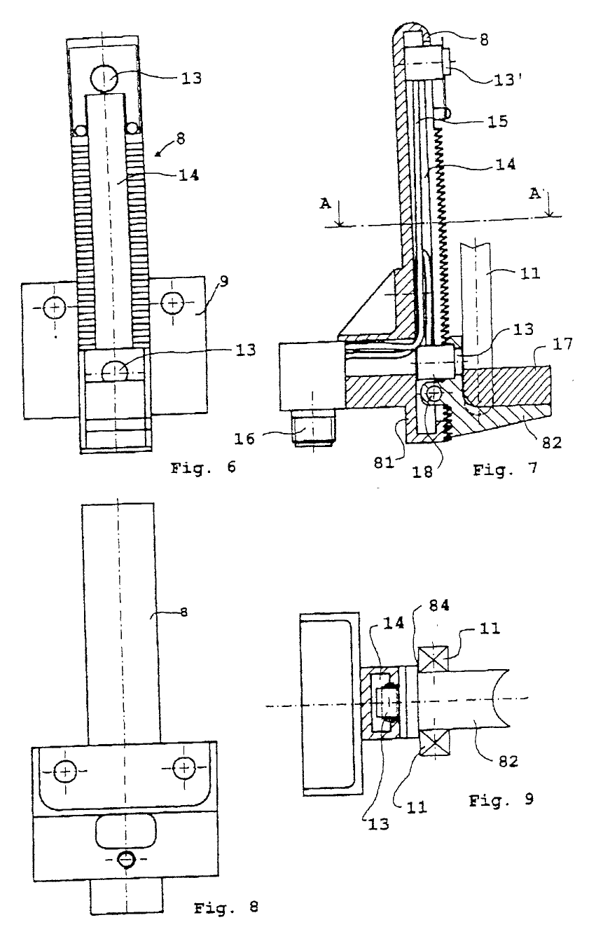

Referring to FIGS. 6 and 7, the support element 8, on the part facing the piston rod, is provided with a groove 14 for accommodating cables 15 leading to sensors 13, 13′, with the said cables 15 coming out of a cable connection 16 arranged on the outer side of the support element 8.

Apart from the afore-mentioned simple bolting of the bottom end 81 of the support element 8 to the header, the support element 8 is provided with at least one latch 9 laterally protruding beyond the engaging hole 6 and together with the said latch 9 being detachably fixed to header 3 by means of bolts 91. The schematical illustration according to FIG. 2 shows four latches 9 at this type, whereas the one according to FIGS. 6, 7 shows two latches 9.

To enable the stop 82 pivotally associated to the support element 8, on the one hand, to be easily displaced on the support element 8 and to be adjusted to the desired height, respectively, and, on the other hand, to take into account the torque load when the extension 7 is mounted on the stop 82, at least one groove 10 is provided in the header 3 at least an one side in parallel to the piston rod 2, which groove 10 is engaged by a guide element arranged on the stop 82. To that effect, reference is made to FIGS. 7 and 9 and also to FIG. 5, showing two such grooves 10 sunk within an internal flank of the said header 3. Through the guide elements 11 engaging the grooves laterally firmly seated on the stop 82, the stop 82 is safely guided in such a way that the latter can be held on the support element 8 in an easily detachable manner simply by means of a ball pawl 18.

Referring to FIG. 5 preferably the header 3, opposite the engaging hole 6, is furnished with a conforming hole 6′ in order to insert the support element 8 with the stop 82 thereof on both sides of the header 3, i.e. on one or on the other side thereof, depending on the requirement. Inserted in the non-used engaging hole is a closure 83 (see FIG. 5) conforming in shape and size to the support element 8 which, however, has no stop 82.

What I claim is as follows:

1. A toggle clamp construction comprising an actuator cylinder (1) provided with a linearly guided piston rod (2), wherein the said piston rod engages a header (3) of the said construction arranged on one end of the actuator cylinder (1) where it is connected via a link (4) to a clamp arm (5) pivotally disposed on the header (3), with the said header (3), in the area between the clamp arm (5) and the actuator cylinder (1) comprising an engaging hole (6), with an extension (7) being arranged on said piston rod (2), a support element (8) being detachably arranged in said engaging hole (6) of the header (3), said support element (8) extending in parallel to the piston rod (2), a stop (82) being disposed on the said support element (8) at the bottom end thereof, and the said stop (82) protruding, for limiting the opening angle of the clamp arm (5), into the path of adjustment of the extension (7) arranged on the piston rod (2).

2. A toggle clamp according to claim 1, characterized in that the stop (82) can be fixed to the support element (8) in different positions of vertical height.

3. A toggle clamp according to claim 1, characterized in that the support element (8) at one end thereof is provided with an arcuate radius (20) inserted in a conforming negative arcuate radius (21) provided on the header (3), and at the other end (81) is detachably fixed to the header.

4. A toggle clamp according to claim 2, characterized in that the support element (8), on the side facing the piston rod, is provided with a toothing (23) engaged by stop (82) provided with a conforming toothing.

5. A toggle clamp according to claim 1, characterized in that a pad (17) is arranged on the stop (82) for attenuating purposes.

6. A toggle clamp according to claim 1, characterized in that a pad (17′) is provided underneath the extension (7) for attenuating purposes.

7. A toggle clamp according to claim 1, characterized in that a sensor (13′) sensing the clamping position, and a sensor (13) sensing the opening position are provided on the support member (8) in a space-adjustable manner.

8. A toggle clamp according to claim 7, characterized in that the sensor (3) sensing the opening position is arranged on stop (82) adjustably disposed on the support element (8).

9. A toggle clamp according to claim 8, characterized in that the support element (8), on the side facing the piston rod, is provided with a groove (14) for accommodating cables (15) leading to the sensors (13, 13′).

10. A toggle clamp according to claim 9, characterized in that the support element (8), on the outer side thereof, is provided with a cable connection (16).

11. A toggle clamp according to claim 1, characterized in that the support element (8) is provided with at least one latch (9) protruding beyond the engaging hole (6) and together with the latter is detachably fixed to the header (3).

12. A toggle clamp according to claim 1, characterized in that a groove (10) is disposed within the header (3) at least an one side thereof in parallel to the piston rod (2), which groove (10) is engaged by a guide element (11) arranged on the stop (82).

13. A toggle clamp according to claim 1, characterized in that the header (3) opposite the engaging hole (6) is provided with a conforming engaging hole (6′).
